(19) United States
(12) Patent Application Publication
(10) Pub. No.: US 2024/0005174 A1
(43) Pub. Date: Jan. 4, 2024

(54) SYSTEM AND METHOD FOR OPTIMIZED GENERATION EVALUATION, SELECTION OF SOLUTIONS USING IMPROVED DISTRIBUTED EVOLUTIONARY COMPUTING

(71) Applicant: Cognizant Technology Solutions US Corp., Teaneck, NJ (US)

(72) Inventors: Hormoz Shahrzad, Dublin, CA (US); Risto Miikkulainen, Stanford, CA (US)

(21) Appl. No.: 17/855,914

(22) Filed: Jul. 1, 2022

(51) Int. Cl. G06N 3/12; G06F 21/60

(52) U.S. Cl. CPC G06N 3/126; G06F 21/606; H04L 63/02

(57) ABSTRACT

A system and method for optimized generation, evaluation and selection of solutions associated with problems of different domain types using distributed evolutionary computing is provided. A request corresponding to problem associated with domain type is sent. A seed population corresponding to the request is generated. The generated seed population corresponding to the request is evaluated based on privately hosted datasets. The evaluated seed population is associated with one or more metrics to generate metric dataset. A best candidate solution associated with the metrics dataset is selected by recursively processing the metrics dataset associated with the evaluated seed population until a termination condition is reached. In the event the termination condition is not reached a next population is generated based on the best candidate solution and evaluated based on the privately hosted datasets. The best candidate solution is selected based on the next population until the termination condition is reached.

### FIELD OF THE INVENTION

The present invention relates generally to the field of distributed evolutionary computing, and more particularly, to a system and a method for optimized generation, evaluation and selection of solutions associated with problems of different domain types based on improved distributed evolutionary computation.

### BACKGROUND OF THE INVENTION

Organizations of different types of domains generate large number of proprietary datasets associated with various functionalities and operations. For example, an organization in a medical domain may generate proprietary datasets relating to customer or patient details, patient's health issues, diagnosis, medicines prescribed, etc. Such organizations process the datasets for determining inter-relationships between datasets in order to provide one or more corresponding recommendations. Generally, dataset processing for solution selection is carried out at a location, which is external to the organizations. As such, there is a paramount need for safety and security of the proprietary datasets from any kind of breach and intrusions.

Typically, evolutionary computation techniques used for solution selection, include, but are not limited to, classical synchronous distribution of population evaluation, asynchronous population evaluation, island model distributed evolution, distributed partial evaluation or distributed age-layering evolution. It has been observed that existing evolutionary computation techniques are associated with various drawbacks, which make the organization's proprietary datasets prone to security and privacy issues. For instance, existing evolutionary computation techniques scale up when solution selection is carried out with similar speed and connectivity using various servers, however, processing time is wasted in waiting for the slowest clients to finish the processing. Further, existing evolutionary computation techniques may use a single server for solution selection which may lead to loss of diversity of the datasets which are processed. Yet further, existing evolutionary computation techniques use peer-to-peer connectivity among clients for data processing which may have a huge time and complexity overhead, especially, if fully connected topology is desired. Further, existing evolutionary computation techniques use a decentralized approach for dataset processing which is undesirable for determining best candidate datasets or optimizing hyper parameters associated with dataset processing using evolution process (e.g., offspring generation). Furthermore, existing evolutionary computation techniques do not have centralized control on evolution engines (i.e., clients) for selection and/or creation of the next generation of candidates (e.g., offspring generation), which makes it difficult to optimize the evolution process. Also, in existing evolutionary computation techniques there is no clean separation of proprietary datasets and application of evolutionary computing techniques for datasets processing. As such, while datasets (which may be proprietary to the organization) remain at the organization's end, the servers still need to know the nature of datasets in order to aggregate partial dataset processing results sent by the organization, which tends to comprise the data security. Similarly, the clients need to execute all selection or procreation logic which are proprietary to the organization and again involves data security concerns.

In light of the aforementioned drawbacks, there is a need for a system and a method which provides for an optimized generation, evaluation and selection of solutions associated with problems of different domain types using an improved distributed evolution computation. There is a need for a system and a method which provides for uniformity in the selection of solution in a secure and private manner. Further, there is a need for a system and a method which provides for processing of datasets for solution selection in a distributed manner. Furthermore, there is a need for a system and a method which provides for a centralized approach for solution selection based on dataset processing.

### SUMMARY OF THE INVENTION

In various embodiment of the present invention, a system for optimized generation, evaluation and selection of solutions associated with problems of different domain types using distributed evolutionary computing is provided. The system comprises sending a request corresponding to a problem associated with a domain type by a first processor to a second processor. Further, the system comprises evaluating, by the first processor, a generated seed population corresponding to the request based on privately hosted datasets. The seed population represents candidate solutions corresponding to the problem associated with the different domain types. Further, the system comprises associating, by the first processor, the evaluated seed population with one or more metrics to generate a metric dataset for transmission to the second processor. The metric dataset represents an irreversible masked evaluated seed population. Further, the system comprises evaluating, by the first processor, a generated next population received from the second processor based on the privately hosted datasets. Lastly, the system comprises transmitting the next population to the second processor for selecting a best candidate solution until a termination condition is reached.

In various embodiments of the present invention, a system for optimized generation, evaluation and selection of solution associated with problems of different domain types using distributed evolutionary computing is provided. The system comprises receiving, by a second processor, a request corresponding to a problem associated with a domain type from a first processor. Further, the system comprises generating, by the second processor, a seed population corresponding to the request. The seed population represents candidate solutions corresponding to the problem associated with the domain type. Further, the system comprises receiving, by the second processor, a metric dataset associated with an evaluated seed population from the first processor. The metrics dataset represents an irreversible masked evaluated seed population. Lastly, the system comprises selecting, by the second processor, a best candidate solution by recursively processing the metrics dataset until a termination condition is reached. In the event the termination condition is not reached then a next population is generated by the second processor based on the best candidate solution.

In various embodiment of the present invention, a method for optimized generation, evaluation and selection of solutions associated with problems of different domain types using distributed evolutionary computing is provided. The method comprises sending a request corresponding to a problem associated with a domain type. Further, the method comprises generating a seed population corresponding to the request. The seed population represents candidate solutions corresponding to the problem associated with the different domain types. Further, the method comprises evaluating the generated seed population corresponding to the request based on privately hosted datasets. Further, the method comprises associating the evaluated seed population with one or more metrics to generate a metric dataset. The metric dataset represents an irreversible masked evaluated seed population. Further, the method comprises selecting a best candidate solution associated with the metrics dataset by recursively processing the metrics dataset associated with the evaluated seed population until a termination condition is reached. In the event the termination condition is not reached a next population is generated based on the best candidate solution. Furthermore, the method comprises evaluating the generated next population based on the privately hosted datasets. Lastly, the method comprises selecting the best candidate solution based on the next population until the termination condition is reached.

In various embodiments of the present invention, a computer program product is provided. The computer program product comprises a non-transitory computer-readable medium having computer program code stored thereon, the computer-readable program code comprising instructions that, when executed by a processor, causes the processor to send a request corresponding to a problem associated with a domain type. Further, a seed population corresponding to the request is generated, wherein the seed population represents candidate solutions corresponding to the problem associated with the different domain types. Further, the generated seed population corresponding to the request is evaluated based on privately hosted datasets. The evaluated seed population is associated with one or more metrics to generate a metric dataset. The metric dataset represents an irreversible masked evaluated seed population. Further, a best candidate solution associated with the metrics dataset is selected by recursively processing the metrics dataset associated with the evaluated seed population until a termination condition is reached. In the event the termination condition is not reached, a next population is generated based on the best candidate solution. Further, the generated next population is evaluated based on the privately hosted datasets. Lastly, the best candidate solution is selected based on the next population until the termination condition is reached.

### BRIEF DESCRIPTION OF THE ACCOMPANYING DRAWINGS

The present invention is described by way of embodiments illustrated in the accompanying drawings wherein:

FIG. 1 is a detailed block diagram of a system for generation, evaluation and selection of solutions associated with problems of different domain types using improved distributed evolutionary computing, in accordance with an embodiment of the present invention;

FIG. 2 illustrates processing and evaluation of population datasets in the form of independently distributed nodes representing various subsystems located at various organizations respectively, in accordance with an embodiment of the present invention;

FIGS. 3 and 3A illustrate a flowchart depicting a method for generation, evaluation and selection of solutions associated with problems of different domain types using improved distributed evolutionary computing, in accordance with an embodiment of the present invention; and

FIG. 4 illustrates an exemplary computer system in which various embodiments of the present invention may be implemented.

### DETAILED DESCRIPTION OF THE INVENTION

The present invention discloses a system and a method which provides for generation, evaluation and selection of solutions associated with problems of different domain types using improved distributed evolutionary computing. The present invention provides for efficient solution selection by processing of datasets in a secure and private manner. The present invention provides for a system and a method for solution selection in a uniform manner. Further, the present invention provides for a system and a method for using a centralized approach for solution selection. Furthermore, the present invention provides for a system and a method for an appropriate separation between datasets processing for solution selection at the server-end and private evaluation of datasets at the client (i.e., organization) end. In the present invention, the server only has access to masked data corresponding to candidate solutions for selection and creation of next generation of candidate solutions, and evaluation of candidate solution is handled at the client-end using private data. Furthermore, the present invention provides for solution selection in an independent manner which is not dependent on the processing environment.

The disclosure is provided in order to enable a person having ordinary skill in the art to practice the invention. Exemplary embodiments herein are provided only for illustrative purposes and various modifications will be readily apparent to persons skilled in the art. The general principles defined herein may be applied to other embodiments and applications without departing from the scope of the invention. The terminology and phraseology used herein is for the purpose of describing exemplary embodiments and should not be considered limiting. Thus, the present invention is to be accorded the widest scope encompassing numerous alternatives, modifications and equivalents consistent with the principles and features disclosed herein. For purposes of clarity, details relating to technical material that is known in the technical fields related to the invention have been briefly described or omitted so as not to unnecessarily obscure the present invention.

The present invention would now be discussed in context of embodiments as illustrated in the accompanying drawings.

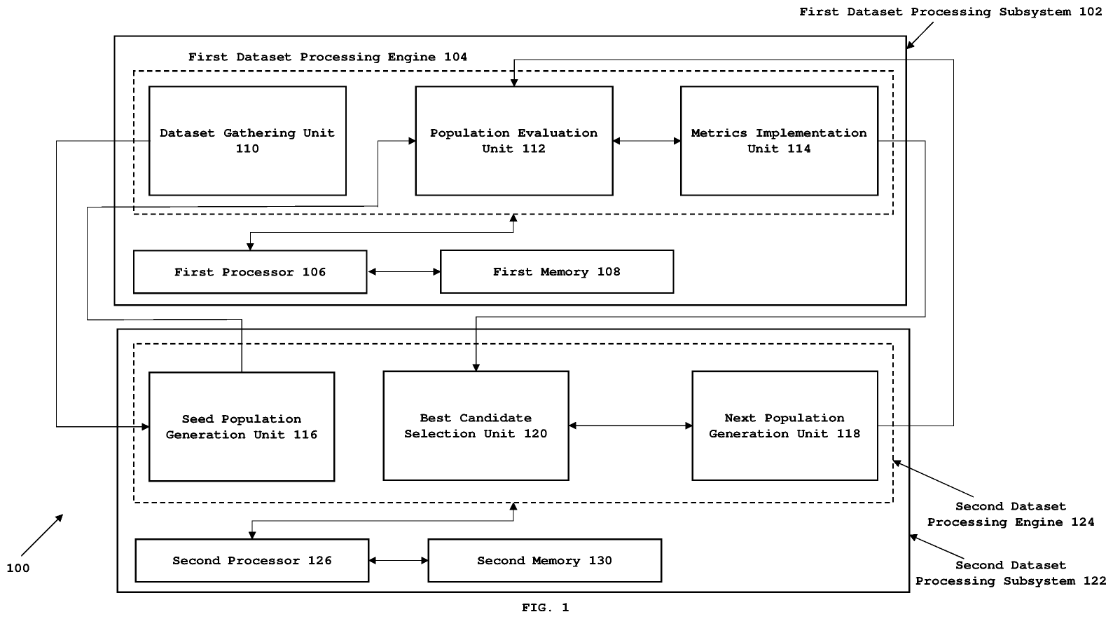

FIG. 1 is a detailed block diagram of a system 100 for generation, evaluation and selection of solutions associated with problems of different domain types using improved distributed evolutionary computing, in accordance with various embodiments of the present invention. Referring to FIG. 1, in an embodiment of the present invention, the system 100 comprises a first dataset processing subsystem 102 and a second dataset processing subsystem 122. The first dataset processing subsystem 102 is referred to as client and the second dataset processing subsystem 122 is referred to as server. The first dataset processing subsystem 102 and the second dataset processing subsystem 122 are connected with each other via a communication channel (not shown). The communication channel (not shown) may include, but is not limited to, a physical transmission medium, such as, a wire, or a logical connection over a multiplexed medium, such as, a radio channel in telecommunications and computer networking. Examples of radio channel in telecommunications and computer networking may include, but are not limited to, a local area network (LAN), a metropolitan area network (MAN) and a wide area network (WAN). In an embodiment of the present invention, the first dataset processing subsystem 102 is installed locally at the organization's end. Each organization may have a specific first datasets processing subsystem 102. Further, the second dataset processing subsystem 122 is located at a remote location, with respect to the first dataset processing subsystem 102.

In an embodiment of the present invention, the first dataset processing subsystem 102 and the second dataset processing subsystem 122 are configured with a built-in-intelligent mechanism for providing efficient solution generation, evaluation and selection associated with problems of different domain types by processing sensitive datasets associated with one or more organizations in a secure and private manner. In an exemplary embodiment of the present invention, the first dataset processing subsystem 102 and the second dataset processing subsystem 122 are configured to implement one or more optimization techniques, such as, distributed evolution computing techniques for solution selection associated with problems of different domain types by processing datasets in a mutually exclusive manner. The first dataset processing subsystem 102 at the organization's end carries out a private evaluation of datasets and the second dataset processing subsystem 122 carries out selection of solutions and generation of a next set of candidate solutions at the remote location. The system 100 provides for a separation of processing of private and sensitive datasets at two different locations (i.e., at the organization's end in the first dataset processing subsystem 102 and at a remote location in the second dataset processing subsystem 122) for solution selection. Therefore, the datasets are processed effectively in a distributed manner, such that each of the first dataset processing subsystem 102 and the second dataset processing subsystem 122 exclusively processes the datasets that is relevant and cannot access the datasets that are not relevant to their part of the processing. Advantageously, there is no data exposure at both the ends i.e., there is no exposure of semantics of data fields of the datasets.

In another embodiment of the present invention, the first dataset processing subsystem 102 and the second dataset processing subsystem 122 are configured to operate in an asynchronous and centralized manner. In an exemplary embodiment of the present invention, multiple first dataset processing subsystems 102 located at the organizations-end are connected to a single second dataset processing subsystem 122 located at a remote location.

In another embodiment of the present invention, the subsystem 102 and subsystem 122 may be implemented in a cloud computing architecture in which data, applications, services, and other resources are stored and delivered through shared datacenters. In an exemplary embodiment of the present invention, the functionalities of the subsystem 102 and subsystem 122 are delivered to a user as Software as a Service (SaaS) or a Platform as a Service (PaaS) over a communication network.

In yet another embodiment of the present invention, the subsystem 102 and subsystem 122 may be implemented as a client-server architecture. In this embodiment of the present invention, a client terminal accesses a server hosting the subsystem 102 and subsystem 122 over a communication network. The client terminals may include but are not limited to a computer, a tablet, or any other wired or wireless terminal. The server may be a centralized or a decentralized server.

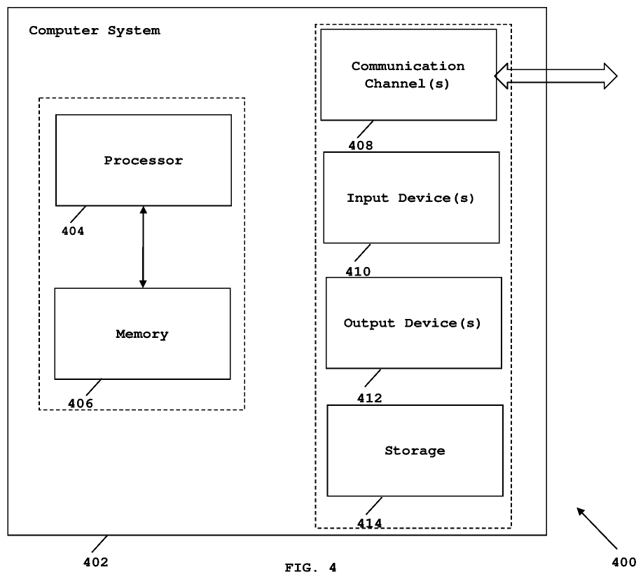

In an embodiment of the present invention, the first dataset processing subsystem 102 comprises a first dataset processing engine 104 (engine 104), a first processor 106 and a first memory 108. In various embodiments of the present invention, the engine 104 is configured to evaluate datasets in a secure and private manner. The various units of the engine 104 are operated via the first processor 106 specifically programmed to execute instructions stored in the first memory 108 for executing respective functionalities of the units of the engine 104 in accordance with various embodiments of the present invention. In an embodiment of the present invention, the second dataset processing subsystem 122 comprises a second datasets processing engine 124 (engine 124), a second processor 126 and a second memory 128. In various embodiments of the present invention, the engine 124 is configured to process the dataset for candidate solution selection and generating next population of solutions. The various units of the engine 124 are operated via the second processor 126 specifically programmed to execute instructions stored in the second memory 128 for executing respective functionalities of the units of the engine 124 in accordance with various embodiments of the present invention. In another embodiment of the present invention, various units of the engine 104 and the engine 124 are operated via the processor 404 (FIG. 4) specifically programmed to execute instructions stored in the memory 406 (FIG. 4) for executing respective functionalities of the units of the engine 104 and the engine 124 in accordance with various embodiments of the present invention.

In an embodiment of the present invention, the engine 104 comprises a dataset gathering unit 110, a population evaluation unit 112 and a metrics implementation unit 114. In an embodiment of the present invention, the engine 122 comprises a seed population generation unit 116, a best candidate selection unit 120 and a next population generation unit 118.

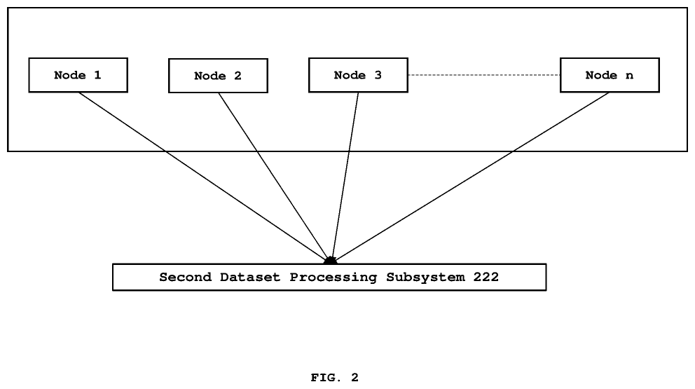

In operation, in an embodiment of the present invention, the dataset gathering unit 110 is configured to send an initial population generation request associated with a problem relating to a domain type to the seed population generation unit 116 for seed population generation. The initial population generation request is associated with problem data of a domain type including, but not limited to, medical domain (e.g. breast cancer datasets, diabetes datasets, heart disease datasets, Intensive Care Unit (ICU) datasets, etc.), banking and finance domain, supply chain domain, marketing domain, etc. In an embodiment of the present invention, the seed population generation unit 116 upon receiving the request from the dataset gathering unit 110 is configured to generate a seed population corresponding to the problem associated with the domain type. The seed population represents candidate solutions corresponding to the problem associated with the domain type encapsulated in the sent request. The seed population generation unit 116 is configured to transmit the generated seed population to the population evaluation unit 112. In an embodiment of the present invention, the population evaluation unit 112 is configured to evaluate the seed population in a distributed and a private manner using privately hosted datasets. The evaluation is carried out in a private manner such that the original dataset is not shared with external systems. In an exemplary embodiment of the present invention, the population evaluation unit 112 which carries out the evaluation against the privately hosted data is protected by a firewall. The seed population is evaluated by the population evaluation unit 112 by processing the seed population in the form of independently distributed nodes (e.g., node 1, node 2, node 3 . . . node n), as illustrated in FIG. 2. In an embodiment of the present invention, the population evaluation unit 112 carries out the evaluation by providing the seed population as an input to one or more evaluation functions (i.e., potential solutions) and the output of the evaluation functions is transmitted to the subsystem 122 (subsystem 222, FIG. 2) for selection and generation of the best solution and the next generation. Evaluation of seed population in various distributed nodes aids in separately carrying out the data evaluation process and best solution selection process, as explained later in the specification.

In an embodiment of the present invention, the metrics implementation unit 114 is configured to receive the evaluated seed population from the population evaluation unit 112 for generating a metric dataset. The population evaluation unit 112 in communication with the metrics implementation unit 114 is configured to associate the evaluated seed population with one or more metrics for generating a metrics dataset. The metric dataset irreversibly masks the evaluated seed population, thereby providing security and privacy for the seed population during processing. In an example, if the candidate solutions comprise functions of three parameters “x”, “y”, and “z” and the population evaluation unit 112 evaluates the function for some private values of “x”, “y”, and “z”, then the metrics implementation unit 114 provides only the function values as one or more metrics datasets, that is, the actual values are hidden. For instance, a private data may be represented as “X”, the evaluation functions represented as “f1”, “f2”, . . . , “fn” and the metrics as “m1”, “m2”, . . . “mn”, the relation between “X”, “f” and “m” is defined as “m=f(X)”. As such, an inverse function for “f” cannot be used to send back “X” by analyzing “m”.

In an embodiment of the present invention, the best candidate selection unit 120 is configured to receive the metrics dataset associated with the evaluated seed population from the metrics implementation unit 114. That is, in the above example, the best candidate selection unit 120 only receives the function values of the parameters “x”, “y”, “z” and the actual values are hidden. The best candidate selection unit 120 is configured to process the metrics dataset for selecting a best candidate solution. In an exemplary embodiment of the present invention, the best candidate solution is selected using a selection technique including, but is not limited to, a tournament selection technique, a ranking selection technique and a multi-objective selection technique. In an exemplary embodiment, if the evaluated seed population relates to diabetes, then the metrics dataset associated with the evaluated seed population, processed by the best candidate selection unit 120, is illustrated as herein below:
(field_1 <=2.2*field_2) and (field_3 >33) ->18; (filed_4 >=1.2*field_5)) ->7; (field_6 >=0.82*field_7) ->17; (field_8>=1.045*field_21)->9; (field_9 >=2.29*field_10) ->1; (field_11 <=0.47*field_12) and (field_10 <=0.47*field_12) and (field_13 >=1.86*field_14) and (field_15 >=1.42*field_11) and (0.18*field_16 >=0.38*field_17) and (0.12*field_18 >=0.15*field_8) and (0.03*field_19 <=0.76*field_20) ->15; and default ->8.
   In an exemplary embodiment of the present invention, the interpretation of the processed metrics dataset is illustrated herein below:
if patient has a respiratory problem but not a neoplasms problem, then prescribe metformin-pioglitazone;
if the person is of any age except 60-70 years, then prescribe glyburide;
if the person has diabetic diagnostic result as positive, then prescribe glipizide-metformin;
if the person has a positive circulatory diagnosis, then prescribe pioglitazone;
if the admission type is new born, then prescribe tolazamide;
if the person is between 30 and 60 years old and has a positive musculoskeletal diagnosis and is Asian and was sent by court/law enforcement agency and was admitted in emergency, then prescribe insulin; and
if none of the above scenarios are present, then prescribe glipizide.

In an embodiment of the present invention, the best candidate selection unit 120 is configured to recursively process the metrics dataset until a termination condition is reached. The termination condition represents a convergence criterion associated with a dataset. In an exemplary embodiment of the present invention, the termination condition is based on a pre-determined criterion associated with the metrics dataset received from the metrics implementation unit 114. In an exemplary embodiment of the present invention, the pre-determined criteria represent a logical function that applies to the metrics for indicating that the termination condition has reached for the solution selection. For example, the pre-determined criteria include a process-related criterion (e.g., total running time of generations or number of generations), a result-related criterion (e.g., accuracy measure of the current solutions), a number of population generations related criterion and a time-related criterion. In an example, the time related pre-determined criteria may include expensive processing time, a deadline or any other event for stopping the solution selection process at a certain time, and taking the best candidate solutions based on limited resources. In an embodiment of the present invention, the best candidate solution associated with the metrics datasets are selected until the termination condition is reached. The metrics dataset corresponding to the best candidate solution are stored at a storage location in the best candidate selection unit 120 for future retrieval, which is provided in the form of output datasets via the best candidate solution unit 120. Advantageously, actual data associated with the organization are not stored on the best candidate selection unit 120, and only the metrics datasets are stored, thereby providing security to the actual data while carrying out the population dataset processing in a private manner.

In an embodiment of the present invention, the next population generation unit 118 is configured to receive the one or more best candidate solution from the best candidate selection unit 120. The next population generation unit 118 is configured to process the best candidate solution for generation of next population, in the event the termination condition is not reached. The next population generation unit 118 is configured to generate next population by applying a mutation process and a cross-over process (i.e., procreation processes) on the one or more best candidate solution based on existing population. In an exemplary embodiment of the present invention, mutation process represents any random changes applied to a part of a solution. Cross-over process represents application of a pick and choose process on a set of solutions i.e., parent solutions (e.g., using weighted average of several numbers as parent solutions to create a new number i.e., a new solution). For example, in the mutation process it may be assumed that the population has selected solutions (solution 1) as illustrated below:

Solution 1

| 0 | 1 | 0 | 0 | 1 | 0 | 1 | 0 |
|---|---|---|---|---|---|---|---|
| 0 | 1 | 2 | 3 | 4 | 5 | 6 | 7 |

The mutation process selects some parts of solution 1 (such as, cells marked as 0, 1 and 2) and flips them to create a new potential solution (solution 2) for the next evaluation phase as shown below:

Solution 2

| 1 | 0 | 1 | 0 | 1 | 0 | 1 | 0 |
|---|---|---|---|---|---|---|---|
| 0 | 1 | 2 | 3 | 4 | 5 | 6 | 7 |

In another example, in a cross-over process, it may be assumed that the population has two selected solutions as shown below:

Solution 3

| 0 | 1 | 0 | 0 | 1 | 0 | 1 | 0 |
|---|---|---|---|---|---|---|---|
| 0 | 1 | 2 | 3 | 4 | 5 | 6 | 7 |

Solution 4

| 1 | 0 | 0 | 1 | 1 | 0 | 0 | 1 |
|---|---|---|---|---|---|---|---|
| 0 | 1 | 2 | 3 | 4 | 5 | 6 | 7 |

In the cross-over process (randomly or based on some information metrics) some parts (the marked cells) of solution 3 and solution 4 are selected to create a new potential solution (solution 5) for the next evaluation phase as shown below:

Solution 5

| 1 | 1 | 0 | 1 | 1 | 0 | 1 | 0 |
|---|---|---|---|---|---|---|---|
| 0 | 1 | 2 | 3 | 4 | 5 | 6 | 7 |

The next population dataset generation unit 118 is configured to transmit the generated next population to the population evaluation unit 112 for evaluation based on the privately hosted datasets. In an exemplary embodiment of the present invention, the population evaluation unit 112 which carries out the evaluation based on the private data to carry out the evaluation is protected by a firewall, and communication of the subsystem 102 with the subsystem 122 is only based on the metrics which are the result of evaluation and the private data is not sent to external systems. Subsequently a best candidate solution is selected by the best candidate selection unit 120 until the termination condition is reached, as explained above in the specification. In an exemplary embodiment of the present invention, two different best candidate selection units 120 may be deployed for selection and storing of the best candidate solution and for selecting the best candidate solution for the mutation and cross-over process. In an exemplary embodiment of the present invention, the best candidate selection unit 120 is a self-learning unit that employs machine learning techniques for processing the metrics dataset to select the best candidate solution and for generating the next population.

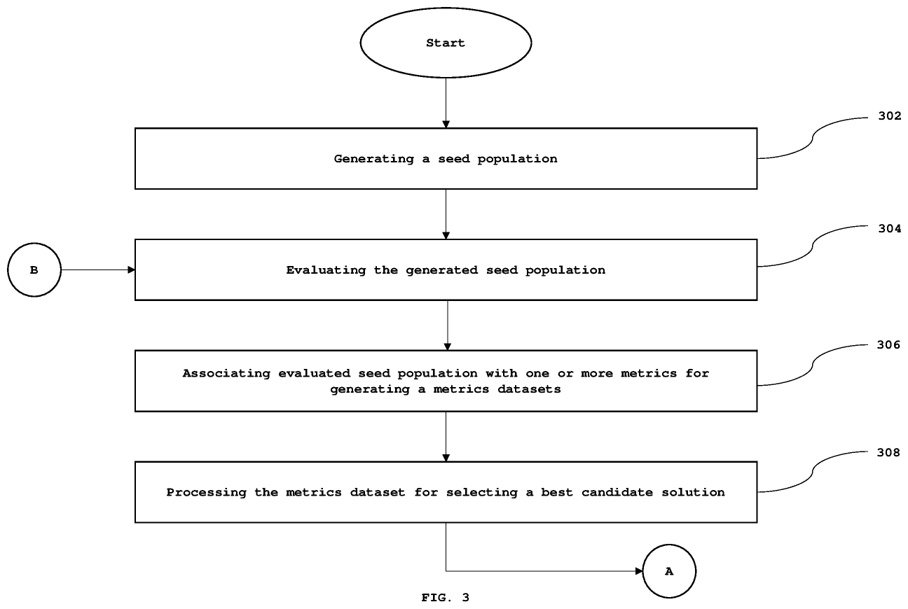

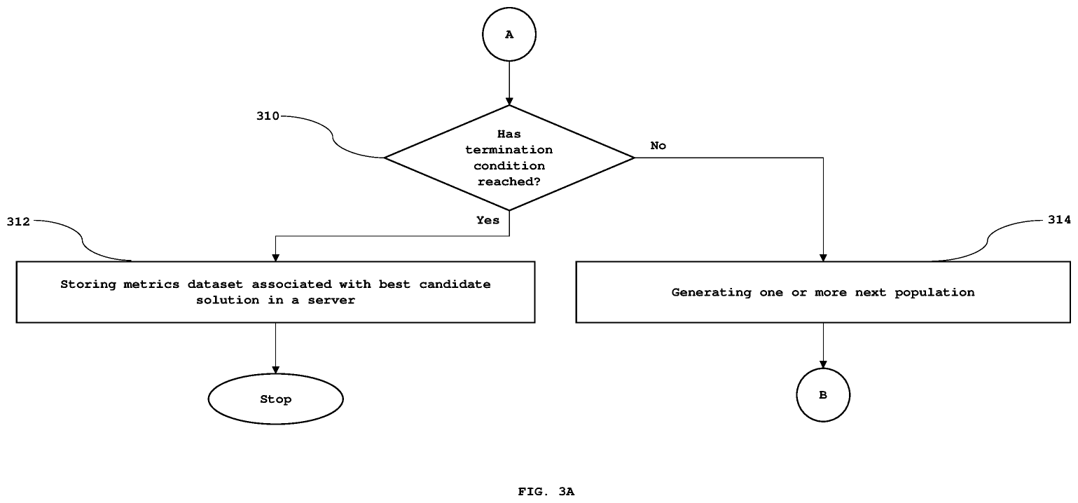

FIGS. 3 and 3A illustrate a flowchart depicting a method for generation, evaluation and selection of solutions associated with problems of different domain types using improved distributed evolutionary computing, in accordance with various embodiments of the present invention.

At step 302, a seed population is generated. In an embodiment of the present invention, the seed population is generated based on an initial population generation request associated with a problem relating to a domain type. The initial population generation request is associated with problem data of a domain type including, but not limited to, the domain type in which the organization operates such as, but not limited to, medical domain (e.g., breast cancer datasets, diabetes datasets, heart disease datasets, Intensive Care Unit (ICU) datasets, etc.), banking and finance domain, supply chain domain, marketing domain, etc. The seed population represents candidate solutions corresponding to the problem associated with the domain type encapsulated in the received request.

At step 304, the generated seed population is evaluated. In an embodiment of the present invention, the seed population is evaluated in a distributed and a private manner using privately hosted datasets. The seed population is evaluated based on processing the seed population in the form of independently distributed nodes (e.g., node 1, node 2, node 3 . . . node n). In an embodiment of the present invention, the seed population is provided as an input to one or more evaluation functions (i.e., potential solutions) and the output of the said evaluation functions is transmitted for selection and generation of best candidate solution and next generation.

At step 306, the evaluated seed population is associated with one or more metrics for generating a metrics dataset. In an embodiment of the present invention, the evaluated seed population is associated with one or more metrics for generating metrics datasets. The metrics dataset irreversibly masks the evaluated seed population, thereby providing security and privacy for the seed population datasets during processing. In an example, if the candidate solutions comprise functions of three parameters “x”, “y”, and “z” and the functions are evaluated for some private values of “x”, “y”, and “z”, then only the function values are provided as one or more metrics datasets, that is, the actual values are hidden. For instance, a private data may be represented as “X”, the evaluation functions represented as “f1”, “f2”, . . . , “fn”, the metrics as “m1”, “m2”, . . . “mn”, and the relation between “X”, “f” and “m” is defined as “m=f(X)”. As such, an inverse function for “f” cannot be used to send back “X” by analyzing “m”.

At step 308, the metrics dataset is processed for selecting a best candidate solution associated with the metrics dataset. In an embodiment of the present invention, the best candidate solution associated with the metrics dataset is selected based on a selection technique including, but not limited to, a tournament selection technique, a ranking selection technique and a multi-objective selection technique. As mentioned in the above example, only function values of the parameters “x”, “y”, “z” are received in the form of the metrics dataset, and the best candidate solution is selected using one or more of the selection techniques. In an embodiment of the present invention, the metrics dataset associated with the evaluated seed population are recursively processed until a termination condition is reached, at step 310. The termination condition represents a convergence criterion associated with a dataset. In an exemplary embodiment of the present invention, the termination condition is based on a pre-determined criterion associated with the metrics dataset. The pre-determined criteria represent a logical function that applies to the metrics for indicating that the termination condition has reached for the solution selection. The pre-determined criteria include a process-related criterion (e.g., total running time of generations or number of generations), a result-related criterion (e.g., accuracy measure of the current solutions), a number of population generations related criterion and a time-related criterion. In an example, the time related pre-determined criteria include expensive processing time, a deadline or any other event for stopping the solution selection process at a certain time, and taking the best candidate solutions based on limited resources. At step 310, if the termination condition is reached, then at step 312, the metrics dataset corresponding to the best candidate solution is stored in the server for future retrieval, which is provided in the form of output datasets.

In the event, at step 310, it is determined that the termination condition is not reached, then at step 314, one or more next population are generated. In an embodiment of the present invention, the next population datasets are generated by applying a mutation process and a cross-over process (i.e., procreation processes) on one or more best candidate solution based on existing population. In an exemplary embodiment of the present invention, mutation process represents any random changes applied to a part of a solution. Cross-over process represents application of a pick and choose process on a set of solutions i.e., parent solutions (e.g., using weighted average of several numbers as parent solutions to create a new number i.e., a new solution). For example, in the mutation process it may be assumed that the population has selected solutions (solution 1) as illustrated below:

Solution 1

| 0 | 1 | 0 | 0 | 1 | 0 | 1 | 0 |
|---|---|---|---|---|---|---|---|
| 0 | 1 | 2 | 3 | 4 | 5 | 6 | 7 |

The mutation process selects some parts of solution 1 (such as, cells marked as 0, 1 and 2) and flips them to create a new potential solution (solution 2) for the next evaluation phase as shown below:

Solution 2

| 1 | 0 | 1 | 0 | 1 | 0 | 1 | 0 |
|---|---|---|---|---|---|---|---|
| 0 | 1 | 2 | 3 | 4 | 5 | 6 | 7 |

In another example, in a cross-over process, it may be assumed that the population has two selected solutions as shown below:

Solution 3

| 0 | 1 | 0 | 0 | 1 | 0 | 1 | 0 |
|---|---|---|---|---|---|---|---|
| 0 | 1 | 2 | 3 | 4 | 5 | 6 | 7 |

Solution 4

| 1 | 0 | 0 | 1 | 1 | 0 | 0 | 1 |
|---|---|---|---|---|---|---|---|
| 0 | 1 | 2 | 3 | 4 | 5 | 6 | 7 |

In the cross-over process (randomly or based on some information metrics) some parts (the marked cells) of solution 3 and solution 4 are selected to create a new potential solution (solution 5) for the next evaluation phase as shown below:

Solution 5

| 1 | 1 | 0 | 1 | 1 | 0 | 1 | 0 |
|---|---|---|---|---|---|---|---|
| 0 | 1 | 2 | 3 | 4 | 5 | 6 | 7 |

In an embodiment of the present invention, the generated next population is evaluated based on the privately hosted datasets, at step 304, and subsequently the best candidate solution is selected from the next population datasets until a termination condition is reached, as explained above in the specification.

Advantageously, in accordance with various embodiments of the present invention, the present invention provides for a system and method for efficient generation, evaluation and selection of solutions associated with problems of different domain types using improved distributed evolutionary computing. The present invention provides for solution generation, evaluation and selection in a secure and a private manner. The present invention provides for a centralized, dynamic and uniform generation, evaluation and selection. Further, the present invention provides for a proper separation between sensitive datasets at the server-end and datasets on the organization's end for solution generation, evaluation and selection. Furthermore, the present invention provides for fast dataset processing for solution generation, evaluation and selection in an independent manner, which is not dependent on the processing environment.

FIG. 4 illustrates an exemplary computer system in which various embodiments of the present invention may be implemented. The computer system 402 comprises a processor 404 and a memory 406. The processor 404 executes program instructions and is a real processor. The computer system 402 is not intended to suggest any limitation as to scope of use or functionality of described embodiments. For example, the computer system 402 may include, but not limited to, a programmed microprocessor, a micro-controller, a peripheral integrated circuit element, and other devices or arrangements of devices that are capable of implementing the steps that constitute the method of the present invention. In an embodiment of the present invention, the memory 406 may store software for implementing various embodiments of the present invention. The computer system 402 may have additional components. For example, the computer system 402 includes one or more communication channels 408, one or more input devices 410, one or more output devices 412, and storage 414. An interconnection mechanism (not shown) such as a bus, controller, or network, interconnects the components of the computer system 402. In various embodiments of the present invention, operating system software (not shown) provides an operating environment for various software executing in the computer system 402 and manages different functionalities of the components of the computer system 402.

The communication channel(s) 408 allow communication over a communication medium to various other computing entities. The communication medium provides information such as program instructions, or other data in a communication media. The communication media includes, but not limited to, wired or wireless methodologies implemented with an electrical, optical, RF, infrared, acoustic, microwave, Bluetooth or other transmission media.

The input device(s) 410 may include, but not limited to, a keyboard, mouse, pen, joystick, trackball, a voice device, a scanning device, touch screen or any another device that is capable of providing input to the computer system 402. In an embodiment of the present invention, the input device(s) 410 may be a sound card or similar device that accepts audio input in analog or digital form. The output device(s) 412 may include, but not limited to, a user interface on CRT or LCD, printer, speaker, CD/DVD writer, or any other device that provides output from the computer system 402.

The storage 414 may include, but not limited to, magnetic disks, magnetic tapes, CD-ROMs, CD-RWs, DVDs, flash drives or any other medium which can be used to store information and can be accessed by the computer system 402. In various embodiments of the present invention, the storage 414 contains program instructions for implementing the described embodiments.

The present invention may suitably be embodied as a computer program product for use with the computer system 402. The method described herein is typically implemented as a computer program product, comprising a set of program instructions which is executed by the computer system 402 or any other similar device. The set of program instructions may be a series of computer readable codes stored on a tangible medium, such as a computer readable storage medium (storage 414), for example, diskette, CD-ROM, ROM, flash drives or hard disk, or transmittable to the computer system 402, via a modem or other interface device, over either a tangible medium, including but not limited to optical or analogue communications channel(s) 408. The implementation of the invention as a computer program product may be in an intangible form using wireless techniques, including but not limited to microwave, infrared, Bluetooth or other transmission techniques. These instructions can be preloaded into a system or recorded on a storage medium such as a CD-ROM, or made available for downloading over a network such as the internet or a mobile telephone network. The series of computer readable instructions may embody all or part of the functionality previously described herein.

The present invention may be implemented in numerous ways including as a system, a method, or a computer program product such as a computer readable storage medium or a computer network wherein programming instructions are communicated from a remote location.

While the exemplary embodiments of the present invention are described and illustrated herein, it will be appreciated that they are merely illustrative. It will be understood by those skilled in the art that various modifications in form and detail may be made therein without departing from or offending the scope of the invention.

We claim:

1. A system for optimized generation, evaluation and selection of solutions associated with problems of different domain types using distributed evolutionary computing, the system comprising:
sending a request corresponding to a problem associated with a domain type by a first processor to a second processor;
evaluating, by the first processor, a generated seed population corresponding to the request based on privately hosted datasets, wherein the seed population represents candidate solutions corresponding to the problem associated with the different domain types;
associating, by the first processor, the evaluated seed population with one or more metrics to generate a metric dataset for transmission to the second processor, wherein the metric dataset represents an irreversible masked evaluated seed population;
evaluating, by the first processor, a generated next population received from the second processor based on the privately hosted datasets; and
transmitting the next population to the second processor for selecting a best candidate solution until a termination condition is reached.

2. The system as claimed in claim 1, wherein the first processor evaluates the seed population in a distributed and a private manner using privately hosted datasets.

3. The system as claimed in claim 1, wherein the first processor evaluates the seed population by processing the seed population in independently distributed nodes based on the privately hosted dataset.

4. The system as claimed in claim 1, wherein the first processor associates the evaluated seed population with one or more metrics based on function values of the parameters of the evaluated seed population to generate the metrics dataset.

5. The system as claimed in claim 1, wherein the first processor evaluates the next population based on privately hosted datasets, and wherein the first processor is protected by a firewall.

6. A system for optimized generation, evaluation and selection of solution associated with problems of different domain types using distributed evolutionary computing, the system comprises:
receiving, by a second processor, a request corresponding to a problem associated with a domain type from a first processor;
generating, by the second processor, a seed population corresponding to the request, wherein the seed population represents candidate solutions corresponding to the problem associated with the domain type;
receiving, by the second processor, a metric dataset associated with an evaluated seed population from the first processor, wherein the metrics dataset represents an irreversible masked evaluated seed population; and
selecting, by the second processor, a best candidate solution by recursively processing the metrics dataset until a termination condition is reached, wherein in the event the termination condition is not reached then a next population is generated by the second processor based on the best candidate solution.

7. The system as claimed in claim 6, wherein the second processor receives function values of parameters associated with the evaluated seed population in the form of the metrics dataset.

8. The system as claimed in claim 6, wherein the second processor selects the best candidate solution associated with the metrics dataset based on one or more selection techniques comprising a tournament selection technique, a ranking selection technique and a multi-objective selection technique.

9. The system as claimed in claim 6, wherein the termination condition represents a convergence criterion associated with the dataset comprising a pre-determined criterion associated with the metrics dataset, and wherein the pre-determined criteria include a process-related criterion, a result-related criterion, a number of population generations related criterion and a time-related criterion.

10. The system as claimed in claim 6, wherein the second processor stores the metrics dataset associated with the best candidate solution in a storage location in the event the termination condition is met, and wherein the metrics dataset is retrievable as an output dataset.

11. The system as claimed in claim 6, wherein the system is a self-learning unit that employs machine learning techniques for processing the metrics dataset to select the best candidate solution and generating the next population.

12. The system as claimed in claim 6, wherein the next population is generated by applying a mutation process and a cross-over process on the best candidate solution based on existing datasets.

13. The system as claimed in claim 6, wherein the second processor transmits the next population to the first processor for evaluation of the next population based on privately hosted datasets and subsequent selection of the best candidate solution by the second processor until the termination condition is reached.

14. A method for optimized generation, evaluation and selection of solutions associated with problems of different domain types using distributed evolutionary computing, the method comprises:
sending a request corresponding to a problem associated with a domain type;
generating a seed population corresponding to the request, wherein the seed population represents candidate solutions corresponding to the problem associated with the different domain types;
evaluating the generated seed population corresponding to the request based on privately hosted datasets;
associating the evaluated seed population with one or more metrics to generate a metric dataset, wherein the metric dataset represents an irreversible masked evaluated seed population;
selecting a best candidate solution associated with the metrics dataset by recursively processing the metrics dataset associated with the evaluated seed population until a termination condition is reached, wherein in the event the termination condition is not reached a next population is generated based on the best candidate solution;
evaluating the generated next population based on the privately hosted datasets; and
selecting the best candidate solution based on the next population until the termination condition is reached.

15. The method as claimed in claim 14, wherein the metrics dataset associated with the evaluated seed population masks the evaluated seed population by processing function values of the parameters of the evaluated seed population.

16. The method as claimed in claim 14, wherein the seed population is evaluated in a distributed and a private manner using privately hosted datasets.

17. The method as claimed in claim 14, wherein the best candidate solution is selected based on one or more of selection techniques comprising a tournament selection technique, a ranking selection technique and a multi-objective selection technique.

18. The method as claimed in claim 14, wherein the termination condition represents a convergence criterion associated with the dataset comprising a pre-determined criterion associated with the metrics dataset and wherein the pre-determined criteria include a process-related criterion, a result-related criterion, a number of population generations related criterion and a time-related criterion.

19. The method as claimed in claim 14, wherein the metrics dataset associated with the best candidate solution is stored in a storage location in the event the termination condition is met, and wherein the metrics dataset is retrievable as an output dataset.

20. The method as claimed in claim 14, wherein the next population is evaluated based on privately hosted datasets.

21. The method as claimed in claim 14, wherein the next population is generated by applying a mutation process and a cross-over process on the best candidate solution based on existing datasets.

22. A computer program product comprising:
a non-transitory computer-readable medium having computer program code stored thereon, the computer-readable program code comprising instructions that, when executed by a processor, causes the processor to:
send a request corresponding to a problem associated with a domain type;
generate a seed population corresponding to the request, wherein the seed population represents candidate solutions corresponding to the problem associated with the different domain types;
evaluate the generated seed population corresponding to the request based on privately hosted datasets;
associate the evaluated seed population with one or more metrics to generate a metric dataset, wherein the metric dataset represents an irreversible masked evaluated seed population;
select a best candidate solution associated with the metrics dataset by recursively processing the metrics dataset associated with the evaluated seed population until a termination condition is reached, wherein in the event the termination condition is not reached a next population is generated based on the best candidate solution;
evaluate the generated next population based on the privately hosted datasets; and
select the best candidate solution based on the next population until the termination condition is reached.
